(19) United States
(12) Patent Application Publication
(10) Pub. No.: US 2020/0265109 A1
(43) Pub. Date: Aug. 20, 2020

(54) DATA SMOOTHING METHOD, AND PROGRAM FOR PERFORMING THE METHOD

(71) Applicant: SHIMADZU CORPORATION, Kyoto-shi (JP)

(72) Inventor: Akira HARADA, Kyoto-shi (JP)

(73) Assignee: SHIMADZU CORPORATION, Kyoto-shi (JP)

(21) Appl. No.: 16/276,994

(22) Filed: Feb. 15, 2019

(51) Int. Cl. G06F 17/17

(52) U.S. Cl. CPC G06F 17/17

(57) ABSTRACT

A data smoothing method which achieves improved reproducibility than conventional methods is provided. With the data smoothing method of the present invention, a standard error of numerical data at each data acquisition point or of data based on the numerical data is calculated, and a smoothing width is determined based on the standard error in such a way that the smoothing width becomes narrower for a data acquisition point for which the standard error is greater. The numerical data at each data acquisition point or data based on the numerical data is smoothed using the determined smoothing width.

### TECHNICAL FIELD

The present invention relates to a smoothing process for data that is acquired at specific intervals, such as measurement data that is acquired by a detector of an analysis device, for example.

### BACKGROUND ART

A detector that is used in a liquid chromatograph, a gas chromatograph or the like, for example, obtains signal intensity for each specific period of time in a form of numerical data, and a chromatogram of a sample is obtained by graphing the numerical data. Numerical data of a signal obtained by the detector includes various noises, and to accurately grasp a trend of a signal waveform, a smoothing process is often performed to smooth the numerical data and to reduce an influence of the noise (for example, see Patent Document 1).

A smoothing process for such discrete data often uses a method of calculating a smoothed value for one point by performing convolutional operation on neighboring data on both sides of the point and a weight function. As the weight function, there are various functions such as a simple average function and a Gaussian function. As a similar method, there are, for example, a method of determining the smoothed value by approximating neighborhood data by a polynomial (Savitzky-Golay method), and an adaptive smoothing method.

### PRIOR ART DOCUMENTS

### Patent Documents

Patent Document 1: Japanese Patent Laid-open Publication No. 2006-242750

### SUMMARY OF THE INVENTION

### Problems to be Solved by the Invention

In the case where data includes a baseline and a peak, the number of pieces of neighboring data on both sides to be used for smoothing (hereinafter “smoothing width”) has to have a smoothing width sufficient to suppress a noise component near the baseline. Normally, the smoothing width is fixed as a smoothing target range, and thus, if a smoothing process is performed on a peak with a width close to the smoothing width or on data at a peak portion with a width narrower than the smoothing width, distortion is caused in data near a peak apex (i.e., value becomes smaller than original data). The distortion affects calculation of a peak height or a peak area, and also, if peaks are close to each other, the peaks are possibly prevented from being separated from each other. That is, with a conventional smoothing method, a problem is sometimes caused with respect to reproducibility of data depending also on the type of the data.

Accordingly, the present invention aims to provide a data smoothing method which achieves improved reproducibility than conventional methods.

### Solutions to the Problems

A data smoothing method according to the present invention is a data smoothing method for smoothing numerical data acquired at a plurality of data acquisition points or data based on the numerical data, by using numerical data at data acquisition points present in a smoothing width including a data acquisition point at which respective numerical data is acquired or data based on the numerical data.

The data smoothing method includes

a standard error calculation step of calculating a standard error of numerical data at each data acquisition point or data based on the numerical data;

a smoothing width determination step, performed after the standard error calculation step, of determining the smoothing width for each of the data acquisition points based on the standard error of the numerical data at each of the data acquisition points or the data based on the numerical data, in such away that the smoothing width becomes narrower for a data acquisition point for which the standard error of the numerical data or the data based on the numerical error is greater; and

a smoothing step of performing a smoothing process on the numerical data at each of the data acquisition points or the data based on the numerical data, by using the numerical data at the data acquisition points present in the smoothing width determined in the smoothing width determination step or the data based on the numerical data.

The “data acquisition point” refers to a point at which numerical data is acquired, and in the case of data that is acquired at specific intervals, the “data acquisition point” refers to each time point of acquisition of the numerical data.

Details of the “standard error” will be given later, but by determining the “standard error” of numerical data at each data acquisition point or data based on the numerical data, a size of variation in the data at the data acquisition points (i.e., a size of a change in a gradient of the data) may be grasped. Accordingly, by determining the standard error, a baseline portion and a range where a change in the gradient of data is great (i.e., an absolute value of a second derivative is large) may be identified in a data series based on numerical values.

With the data smoothing method of the present invention, in the smoothing width determination step, the smoothing width for each of the data acquisition points may be determined based on the standard error that is calculated in the standard error calculation step and a smoothing width table that is prepared in advance. This facilitates determination of the smoothing width.

Further, a normalization step, performed after the standard error calculation step and before the smoothing width determination step, of normalizing the standard error that is calculated in the standard error calculation step by a predetermined calculation method may be provided, where, in the smoothing width determination step, the smoothing width for each of the data acquisition points may be determined based on the standard error that is normalized in the normalization step and a smoothing width table that is prepared in advance.

A program according to the present invention performs the data smoothing method described above, by being executed by a computer.

### Effects of the Invention

With the data smoothing method according to the present invention, a standard error is calculated for numerical data at each data acquisition point or data that is based on the numerical data, and a smoothing width is determined based on the standard error in such a way that the smoothing width is more reduced for a data acquisition point with a greater standard error, and thus, the smoothing width is great in a range, such as a baseline portion, where a change in a gradient of data is small (i.e., an absolute value of a second derivative is small), and the smoothing width is small in a range, such as a peak portion, where the change in the gradient of data is great (i.e., the absolute value of the second derivative is large). Accordingly, smoothed data close to original data can be acquired, and reproducibility is improved compared to that of a conventional smoothing process.

The program according to the present invention is able to perform the smoothing method described above, and a smoothing process which achieves high reproducibility may be executed on a computer.

### BRIEF DESCRIPTION OF THE DRAWINGS

FIG. 1 is a flowchart showing an example of a data smoothing method.

FIG. 2 is a graph showing an example of a signal waveform before execution of a smoothing process.

FIG. 3 is a graph showing a waveform of a standard error of each piece of numerical data of a same signal waveform and an original waveform in a superimposed manner.

FIG. 4 is a graph showing, in a superimposed manner, a waveform after execution of the smoothing process on each piece of numerical data of the same signal waveform and the original waveform.

FIG. 5 is a graph showing, in a superimposed manner, as an example of a signal waveform before execution of the smoothing process, a waveform of a first derivative value of a melting curve and a waveform of a standard error of each first derivative value.

FIG. 6 is a graph showing waveforms after execution of the smoothing process on same first derivative values.

FIG. 7 is a block diagram showing an example of a configuration of a computer on which a smoothing program is installed.

### EMBODIMENTS OF THE INVENTION

Hereinafter, an example of a data smoothing method according to the present invention, and a program for performing the method will be described.

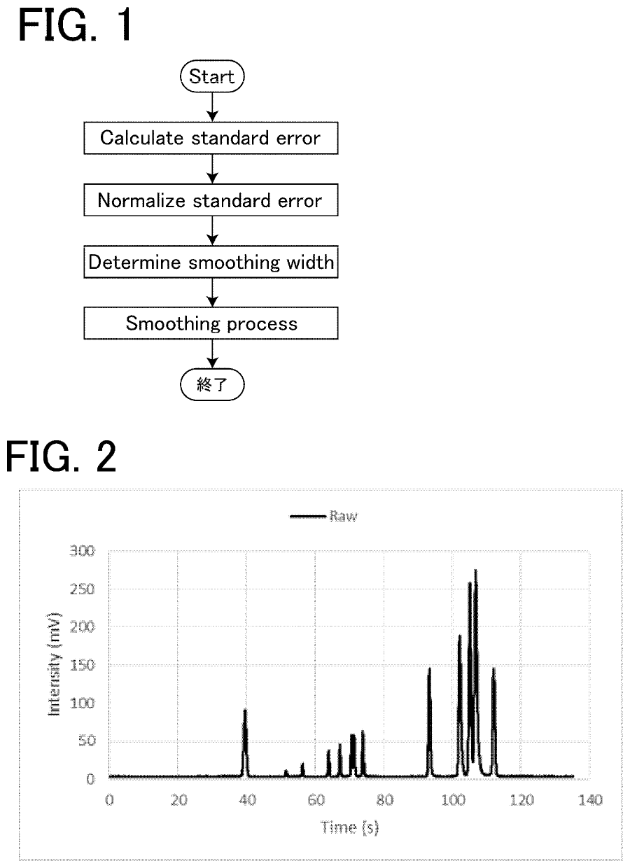

First, an outline of the smoothing method of the present example will be described with reference to a flowchart in FIG. 1.

A standard error of numerical data that is acquired at each data acquisition point at specific intervals by a detector of an analysis device or of data that is based on the numerical data is calculated. The standard error may be determined by dividing residual sum of squares for a regression line by degrees of freedom and by taking a square root, for example. When a regression line calculated from numerical data is represented by Y=ax+b, a standard error SE may be determined by the following Expression (1).

$$SE = \sqrt{\frac{1}{( n - 2 )} {\sum }_{i = 1}^{n} {( {y}_{i} - {Y}_{i} )}^{2}} \qquad ( 1 )$$

Here, yᵢ is numerical data at a data acquisition point i, Yᵢ is a predicted value at the data acquisition point i based on a regression line, and n is a standard error calculation width that is determined in advance. The standard error calculation width indicates that calculation of a standard error is performed by using numerical data at data acquisition points in a range of ±A of a corresponding data acquisition point. That is, n=2A+1 is true. Accordingly, to calculate the standard error for the data acquisition point i, pieces of numerical data at data acquisition points (i−A) to (i+A) are used.

After the standard error is calculated for each data acquisition point, normalization of the standard error is performed. Normalization of the standard error is correction of the standard error to a predetermined scale by using a factor or the like that is prepared in advance, such that a smoothing width may be determined by applying the standard error to a table, for determining a smoothing width, that is prepared in advance. Such a normalized standard error will be referred to below as a “normalized standard error”.

After the standard error is normalized, the normalized standard error is applied to a table for determining the smoothing width (hereinafter referred to as “smoothing width table”) such as Table 2 or Table 2 shown below, and a smoothing width to be applied to the smoothing process for each data acquisition point is determined. A smoothing width means that, to perform a smoothing process on a data acquisition point i, pieces of numerical data in a range of ±B of the data acquisition point i, or in other words, pieces of numerical data at data acquisition points (i−B) to (i+B), are used. In the following, “B” indicating front and rear widths of the smoothing width will be referred to as “smoothing half width”.

As is clear from Table 2 and Table 3, the smoothing width is set to be smaller as the standard error (normalized standard error) is greater. At a data acquisition point with a great standard error, a gradient of numerical data has a great variation width with respect to preceding and following data acquisition points, and thus, by performing a smoothing process with a narrow smoothing width on the numerical data at such a data acquisition point, a value close to the original data may be obtained as the smoothed data.

After determining the smoothing width in the above manner, a smoothing process is performed on the numerical data at each data acquisition point by using the smoothing width. There are various methods for the smoothing process, and any of the methods may be used; for example, a Savitzky-Golay method may be cited. With smoothing by the Savitzky-Golay method, calculation for smoothing is performed by using coefficients shown in Table 1 below.

TABLE 1

| | | | | | | | | | | |
|---|---|---|---|---|---|---|---|---|---|---|
| Width | 3 | 5 | 7 | 9 | 11 | 13 | 15 | 17 | 19 | 21 |
| Half width | 1 | 2 | 3 | 4 | 5 | 6 | 7 | 8 | 9 | 10 |
| Norm | 5 | 35 | 105 | 231 | 429 | 715 | 1105 | 1615 | 2261 | 3059 |
| 0 | 5 | 17 | 35 | 59 | 89 | 125 | 167 | 215 | 269 | 329 |
| 1 | 0 | 12 | 30 | 54 | 84 | 120 | 162 | 210 | 264 | 324 |
| 2 | | −3 | 15 | 39 | 69 | 105 | 147 | 195 | 249 | 309 |
| 3 | | | −10 | 14 | 44 | 80 | 122 | 170 | 224 | 284 |
| 4 | | | | −21 | 9 | 45 | 87 | 135 | 189 | 249 |
| 5 | | | | | −36 | 0 | 42 | 90 | 144 | 204 |
| 6 | | | | | | −55 | −13 | 35 | 89 | 149 |
| 7 | | | | | | | −78 | −30 | 24 | 84 |
| 8 | | | | | | | | −105 | −51 | 9 |
| 9 | | | | | | | | | −136 | −76 |
| 10 | | | | | | | | | | −171 |

In Table 1, numerical values in a top row indicate a smoothing width (Width), and numerical values in a second row indicate a smoothing half width (Half Width). Numerical values in third and subsequent rows indicate coefficients that are used for calculation for smoothing. For example, in smoothing for a data acquisition point for which the smoothing width is determined to be “7”, coefficients listed in a fourth column from the left are used, and the following Expression (2) is established. Numerical data is smoothed by using Expression (2), and smoothed data Y′ᵢ is thereby calculated.

Y′ᵢ= 1/105(35yᵢ+30(yᵢ₋₁+yᵢ₊₁)+15(y₁₋₂+yᵢ₊₂)−10(yᵢ₋₃+yᵢ₊₃)) (2)

### EXAMPLE 1

An example of performing a smoothing process on a signal value waveform in FIG. 2, obtained by the detector of the analysis device, by the smoothing method described above will be described.

### (Calculation of Standard Error)

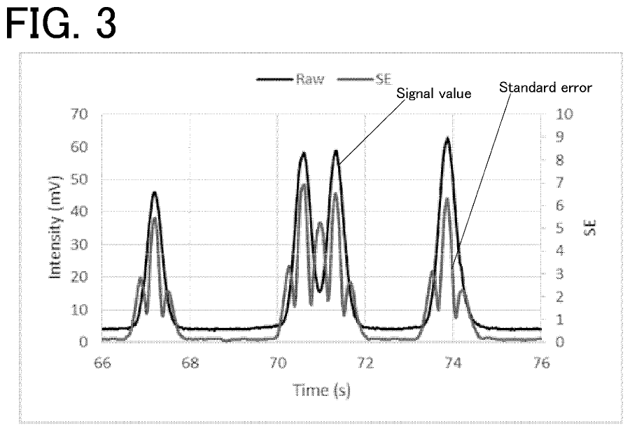

First, the standard error SE of original numerical data that is obtained by the detector is calculated. The standard error SE here is a standard error on a predicted value based on a regression line of neighboring 2A+1 points, and is calculated by using Expression (1) described above. The standard error SE and the original numerical data are shown superimposed with each other as shown in FIG. 3. As can be seen in FIG. 3, the standard error SE at each data acquisition point indicates an amount of change in the gradient of the numerical data with respect to the numerical data at preceding and following data acquisition points.

### (Normalization of Standard Error)

The standard error SE of the numerical data at each data acquisition point is normalized so as to be applicable to the smoothing width table of Table 2 prepared in advance, and a normalized standard error SE′ is thus obtained.

### (Determination of Smoothing Width)

Then, a standard deviation S and a mean M of the normalized standard errors SE′ in a baseline range that is determined in advance are determined. In the present example, the standard deviation S and the mean M are used as a basis for determining the smoothing width. A level to which each normalized standard error SE′ corresponds is extracted from levels shown in the smoothing width table of Table 2, and the smoothing half width is thus determined. Here, “C” is a smoothing width adjustment level and takes a value smaller than a smoothing half width B, and “d” is a smoothing width adjustment constant and takes a value greater than 0.

TABLE 2

| Level | Normalized Standard Error | Smoothing Half Width |
|---|---|---|
| 1 | SE′ ≤ M + dS | B |
| 2 | M + dS < SE′ ≤ M + 2dS | B − 1 |
| . | . | . |
| . | . | . |
| . | . | . |
| C | M + (C − 1)d < SE′ | B − (C − 1) |

### (Smoothing Process)

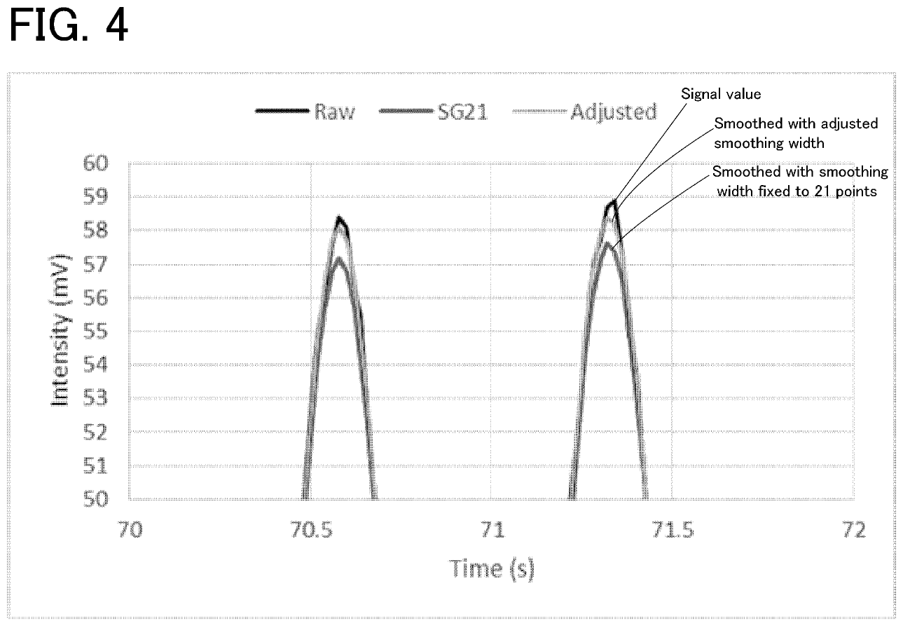

The numerical data at each data acquisition point is smoothed by the Savitzky-Golay method described above, by using the normalized standard error SE′ and the smoothing half width determined based on Table 2 described above. The result is shown in FIG. 4. FIG. 4 extracts and shows in an enlarged manner apex portions of specific peaks from the waveform shown in FIG. 2, and shows in a superimposed manner an original signal value waveform, a waveform obtained by adjusting the smoothing width based on the standard error and by performing smoothing, and a waveform obtained by fixing the smoothing width to 21 points and by performing smoothing.

As is clear from FIG. 4, when the smoothing process is performed by fixing the smoothing width to 21 points, a height of a peak waveform is reduced to lower than the original signal value waveform, but reduction in the height of the peak waveform is suppressed by adjusting the smoothing width by using the standard error, and a waveform that is close to the original peak waveform may be obtained.

### EXAMPLE 2

A description will be given of an example of performing the smoothing process on a melting curve obtained by measuring a substance.

### (Calculation of Standard Error)

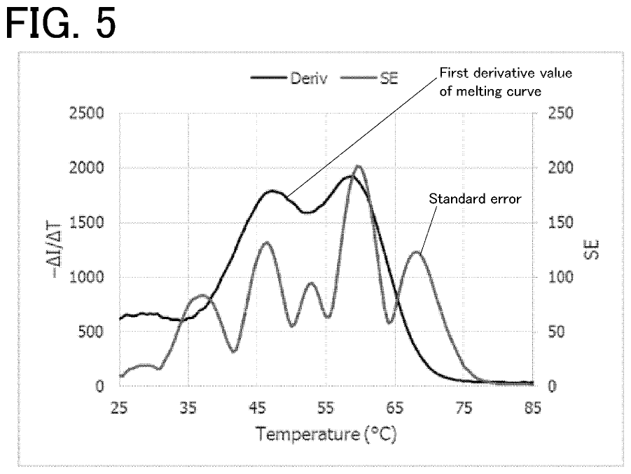

FIG. 5 shows, in a superimposed manner, a waveform of a value obtained by inverting a sign of a first derivative value of a melting curve that is obtained by measuring a substance (i.e., data that is based on the original numerical data), and a waveform of the standard error SE. The standard error SE here is the standard error on the predicted value based on the regression line of the neighboring 2A+1 points for each data acquisition point, and is calculated by using Expression (1) described above.

### (Normalization of Standard Error)

The standard error SE of the numerical data at each data acquisition point is normalized so as to be applicable to a smoothing width table of Table 3 prepared in advance, and a normalized standard error SE′ is thus obtained.

### (Determination of Smoothing Width)

A level to which each normalized standard error SE′ corresponds is extracted from levels shown in the smoothing width table of Table 3, and the smoothing half width is thus determined. Here, “C” is a smoothing width adjustment level and takes a value smaller than a smoothing half width B, and “d” is a smoothing width adjustment constant and takes a value greater than (−1/C) and smaller than (1/C).

TABLE 3

| Level | Normalized Standard Error | Smoothing Half Width |
|---|---|---|
| 1 | SE′ ≤ 1/C + d | B |
| 2 | 1/C + d < SE′ ≤ 2/C + d | B − 1 |
| . | . | . |
| . | . | . |
| . | . | . |
| C | (c − 1)/C + d < SE′ | B − (C − 1) |

### (Smoothing Process)

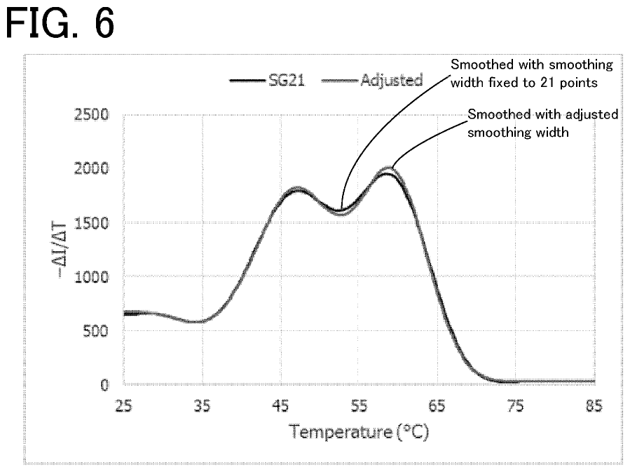

The numerical data at each data acquisition point is smoothed by the Savitzky-Golay method described above, by using the normalized standard error SE′ and the smoothing half width determined based on Table 3 described above. The result is shown in FIG. 6. FIG. 6 shows, in a superimposed manner, a waveform obtained by adjusting the smoothing width based on the standard error and by performing smoothing, and a waveform obtained by fixing the smoothing width to 21 points and by performing smoothing.

As is clear from FIG. 6, by adjusting the smoothing width using the standard error, an apex height is increased at peak portions and a trough between peaks becomes deeper than in a case where the smoothing process is performed by fixing the smoothing width to 21 points. Therefore, by adjusting the smoothing width using the standard error, adjacent peaks are more desirably separated than in a case where the smoothing width is fixed to 21 points.

In the examples described above, before determining the smoothing width, the standard error SE is normalized and the normalized standard error SE′ is determined, and the smoothing width is determined based on the normalized standard error SE′. However, the present invention is not limited to such a case, and a smoothing width table may be prepared in advance so as to enable determination of the smoothing width based on the standard error SE, and the smoothing width may be determined by applying the standard error SE to the smoothing width table.

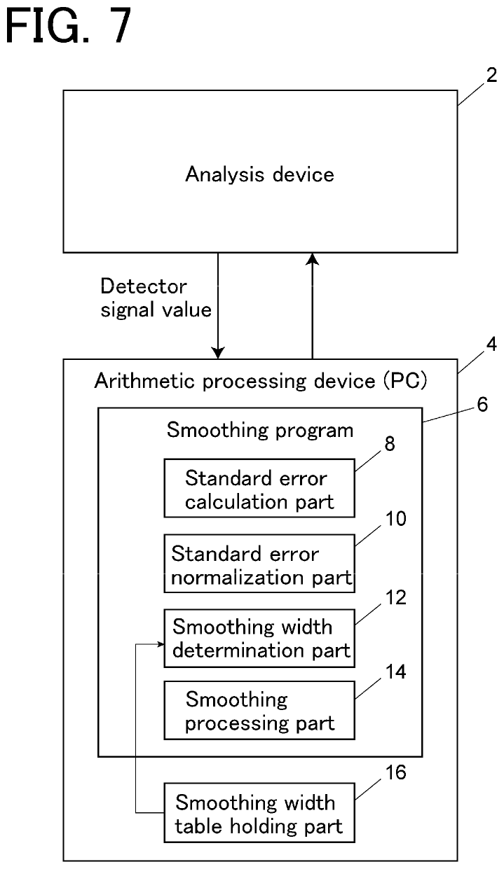

Next, an example of a computer on which a smoothing program for performing the smoothing method described above is installed will be described with reference to FIG. 7.

An arithmetic processing device 4 is electrically connected to an analysis device 2. The arithmetic processing device 4 is implemented by, for example, a general-purpose personal computer (PC) but may alternatively be a computer dedicated to the analysis device 2. Detector signals which are acquired at the analysis device 2 at specific intervals are input as numerical data to the arithmetic processing device 4. A smoothing program 6 for smoothing the numerical data output from the analysis device 2 is stored in the arithmetic processing device 4.

The smoothing program 6 is configured of a standard error calculation part 8, a standard error normalization part 10, a smoothing width determination part 12, and a smoothing processing part 14. The arithmetic processing device 4 includes a smoothing width table holding part 16 holding a smoothing width table that is created in advance (such as Table 2 or Table 3). The smoothing width table holding part 16 is implemented by an area in a data storage device provided inside the arithmetic processing device 4.

The standard error calculation part 8 is configured to calculate the standard error SE of the numerical data at each data acquisition point or of data that is based on the numerical data, by using Expression (1) described above.

The standard error normalization part 10 is configured to determine the normalized standard error SE′ by normalizing the standard error SE to be applicable to the smoothing width table. Additionally, the standard error normalization part 10 is not an indispensable structural element, and is not required in the case where the standard error SE is to be used as it is for determination of the smoothing width.

The smoothing width determination part 12 is configured to determine the smoothing width by applying the normalized standard error SE′ or the standard error SE to the smoothing width table.

The smoothing processing part 14 is configured to perform, using the smoothing width determined by the smoothing width determination part 12, a smoothing process on the numerical data at each data acquisition point or on data that is based on the numerical data, by using a smoothing processing method such as the Savitzky-Golay method.

### DESCRIPTION OF REFERENCE SIGNS

2: Analysis device

4: Arithmetic processing device

6: Smoothing program

8: Standard error calculation part

10: Standard error normalization part

12: Smoothing width determination part

14: Smoothing processing part

16: Smoothing width table holding part

1. A data smoothing method for smoothing numerical data acquired at a plurality of data acquisition points or data based on the numerical data, by using numerical data at data acquisition points present in a smoothing width including a data acquisition point at which respective numerical data is acquired or data based on the numerical data, the method comprising:
a standard error calculation step of calculating a standard error of numerical data at each data acquisition point or data based on the numerical data;
a smoothing width determination step, performed after the standard error calculation step, of determining the smoothing width for each of the data acquisition points based on the standard error of the numerical data at each of the data acquisition points or the data based on the numerical data, in such a way that the smoothing width becomes narrower for a data acquisition point for which the standard error of the numerical data or the data based on the numerical error is greater; and
a smoothing step of performing a smoothing process on the numerical data at each of the data acquisition points or the data based on the numerical data, by using the numerical data at the data acquisition points present in the smoothing width determined in the smoothing width determination step or the data based on the numerical data.

2. The data smoothing method according to claim 1, wherein, in the smoothing width determination step, the smoothing width for each of the data acquisition points is determined based on the standard error that is calculated in the standard error calculation step and a smoothing width table that is prepared in advance.

3. The data smoothing method according to claim 2, further comprising a normalization step, performed after the standard error calculation step and before the smoothing width determination step, of normalizing the standard error that is calculated in the standard error calculation step by a predetermined calculation method, wherein
in the smoothing width determination step, the smoothing width for each of the data acquisition points is determined based on the standard error that is normalized in the normalization step and a smoothing width table that is prepared in advance.

4. A program, wherein the program performs the data smoothing method according to claim 1 by being executed by a computer.
